(19) United States
(12) Patent Application Publication
(10) Pub. No.: US 2008/0113105 A1
(43) Pub. Date: May 15, 2008

(54) Coating Formed By Thermal Spraying And Methods For The Formation Thereof

(75) Inventor: Carmi Raz, Gizo (IL)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: JOMA International AS, Royrvik (NO)

(21) Appl. No.: 11/737,501

(22) Filed: Apr. 19, 2007

(30) Foreign Application Priority Data
Apr. 20, 2006 (IL) 175,045

(51) Int. Cl. B05D 1/08

(52) U.S. Cl. 427/446

(57) ABSTRACT

The invention provides a coating formed by thermal spraying of a feed-composition, said feed-composition comprising: discreet micron-scale particles and discreet agglomerates of nano-scale particles.

The present invention relates to a coating formed by the thermal spraying of a feed composition and to a method for the formation of a coating on a surface by the thermal spraying of said feed-composition thereon.

Thermal spray is the common name for a group of processes that are used to coat surfaces with high velocity hot particles of materials such as metals, oxides or polymers.

In all those processes the particles of coating materials are heated to a temperature that causes them to melt or to soften, and are then accelerated toward the surface to be coated, e.g., by high velocity gas.

The impact of the accelerated particles on the surface builds a thin but strong film on the surface of the material being coated.

There are three main feed forms of materials for thermal spraying processes: wires, powders and solutions. Single composition oxide ceramics or multiple composition oxide materials are usually in a powder form.

Flame and plasma methods are probably the most widespread methods used for thermal spraying. In these methods excessive heat is generated in the jets, causing the sprayed material to melt or soften. The high speed of the jets causes the spraying of the molten particles to be effected at a high velocity, leading to very dense and high performance coatings.

Conventionally the powder particles are in the size range of about 10-50 micrometers.

In the last decade, the use of nanometer sized powder particles as feed materials was suggested in numerous studies, such as in the following patents:

U.S. Pat. No. 5,939,146; U.S. Pat. No. 6,025,034; U.S. Pat. No. 6,277,448; U.S. Pat. No. 6,287,714; U.S. Pat. No. 6,372,364; U.S. Pat. No. 6,579,573; and U.S. Pat. No. 6,689,424. Only U.S. Pat. No. 6,723,387 describes a thermal spraying method that uses the blending of micron-scale particles with nano-scale particles. This patent differs from the present specification as will be described hereinafter.

As mentioned, nanometer powders have only recently been used as feed materials for thermal spraying. The coatings composed of nano-scale particles, especially nano-scale oxide materials, have shown better wear and corrosion resistance than the conventional micron-scale ones. However, for some parameters such as cracking progression, the coatings composed of nano-scale particles are of an inferior quality compared with those of the conventional micron-scale ones.

The main objective of the present invention is to provide coating compositions characterized by improved properties when compared to those in both the conventional micron-scale coatings as well as in the nano-scale coatings. Another objective of the present invention is the production of cost effective coatings compared to the nano-scale ones.

Currently there is a need for coatings that are characterized by improved properties and cost effectiveness compared with micron-scale coatings, as well as to provide nano-scale coatings that are processed by using conventional equipment and conventional feeders present in the market.

### DISCLOSURE OF THE INVENTION

With this state of the art in mind, there is now provided according to the present invention a coating formed by thermal spraying of a feed-composition comprising:
a) discreet micron-scale particles; and
b) discreet agglomerates of nano-scale particles.

In preferred embodiments of the present invention the weight ratio between said micron-scale and nano-scale particles is between about 10:90 and about 90:10.

In especially preferred embodiments of the present invention the weight ratio between said micron-scale and nano-scale particles is between about 10:90 and about 45:55.

Preferably the weight ratio between said micron-scale and nano-scale particles is approximately constant.

In preferred embodiments said coating is comprised of at least two layers having different ratios between said micron-scale and nano-scale particles.

In especially preferred embodiments the weight ratio between said micron-scale and nano-scale particles varies along the coating.

In another preferred embodiment, the majority of said agglomerates is in a spherical shape.

Especially preferred is a coating wherein the majority of said nano-scale particles and of said micron-scale particles are at least softened during the thermal spraying.

In still another preferred embodiment the mean diameter of the majority of said agglomerates is such that the mean heat transfer across said agglomerates is similar to that across the micron-scale particles.

More specifically, the mean diameter of said agglomerates is such that it causes the mean time-period of the heat transfer from the aggregate surface towards its midpoint to be similar to or in the same order of magnitude as the mean time-period of the heat transfer along said micron-scale particles.

Otherwise stated, in the preferred embodiments of the present invention the discreet agglomerates of nano-scale particles are formed to be substantially of the same size as the discreet micron-scale particles so that they can be used with the same equipment.

In preferred embodiments of the present invention said feed composition is in a form selected from the group consisting of powders, wires and solutions.

Preferably said feed composition is in a powder form.

In preferred embodiments said coating is used in an application selected from the group consisting of the automobile-industry, the aircraft-industry, the shipping-industry, engines, turbines, prosthetics or other applications wherein resistance to crack-progression is important.

In another preferred embodiment of the present invention there is now provided an article of manufacture whenever provided with a coating composition according to the present invention.

In another aspect of the present invention there is now provided a method for the formation of a coating comprising the steps of:
(a) preparing a feed-composition comprising discreet micron-scale particles and discreet agglomerates of nano-scale particles; and
(b) thermal spraying of said feed-composition onto a surface.

In preferred embodiments of the present invention said spraying is of a mixture of discreet micron-scale particles and discreet agglomerates of nano-scale particles from a single spraying machine.

Preferably said method is used in an application selected from the group consisting of automobile-industry, aircrafts-industry, shipping-industry, engines-coating, turbines-coating, prosthesis or other applications wherein resistance to crack-progression is important.

In another preferred embodiment of the present invention there is now provided a coating produced by a method as described above.

The coating according to the present invention has improved properties compared with the conventional micron-scale coating and unexpectedly improved properties compared with coatings composed of only nano-scale particles. In particular the resistance to cracking progression of the coating was improved significantly by the addition of micron-scale particles to the nano-scale ones.

In the present specification, resistance to cracking progression refers to a slower process of minor cracks progressing into large cracks, compared to that of the conventional micron-scale coating and coatings composed of only nano-scale particles. Cracking progression may damage the coating properties.

As known in the literature, basically any materials that are available in a “sprayable” form and are stable at spraying temperature, may be applied as feedstock for coating by thermal spray processes. Materials that do tend to chemically decompose at that temperature may be treated in order to use them as feedstock for spraying, e.g. coating them with other materials. The thermal sprayed particles useful in the present specification can be selected from the known thermal sprayed particles, including but not being limited to particles selected from the group consisting of metals, alloys, ceramics and combinations thereof.

The processing of metals by thermal spraying is one of the main preferred embodiments of the present specification.

Aluminum, nickel, copper, chromium, zinc, and molybdenum are materials which are widely used for thermal spraying. Of great significance are the refractory metals, which are typically processed with VPS (Vacuum Plasma Spraying) due to their high sensitivity to oxygen.

In preferred embodiments large numbers of metallic alloys are also used for thermal spray applications. NiAl, and NiCr-alloys are preferably used as a bond coat. Due to an exothermal reaction in the Nickel-Aluminum alloy, partial fusion/welding between the coating and the substrate takes place, improving the bond. The main reason for applying these materials as bond coatings, however, is their ductility, which allows the reduction/mitigation of stresses between the substrate and the coating material.

Especially of great technical and economical significance are the MCrAIY alloys, wherein M designates a metal. These materials when applied to nickel, cobalt, or iron bases prove to be very resistant against high temperature corrosion.

In preferred embodiments wear resistance is obtained by adding carbon, silicon, or boron to alloys of Fe, Co, and Ni, to form hard alloys. This high wear resistance, often combined with good corrosion resistance, is due to the formation of hard phases (carbides, borides), which precipitate as primary/secondary carbides or as binary/ternary eutectics.

Preferably the metallic hard alloys are formed from chromium, tungsten, molybdenum, and vanadium. Chromium is also applied for reasons of corrosion protection. The metalloids, carbon, boron, and silicon form together with the hard compounds homogeneously dispersed, hard phases in a ductile, eutecticly solidified matrix (binder).

Of great interest are hard alloys based on Co. These materials, as well as Fe-hard alloys, are mainly applied through welding, or thermal spray processes.

Ni-hard alloys are preferably used for flame spraying with post-heat-treatment, since they have self-fluxing properties due to boron and silicon contents. Further preferred systems are CoMoSi (TribaloyTM) and NiMo (HastelloyTM). Tribaloys are mainly used for friction and wear applications. Hastelloys are advantageous for corrosion protection applications and the performance of nickel in reducing corrosion media is improved by adding molybdenum. NiMo-alloys with added chromium are mainly preferred in case of oxidizing corrosion conditions.

In preferred embodiments of the present invention there are used ceramic particles that are used in thermal spraying due to their corrosion resistant behavior, hardness, and temperature stability. Ceramic hard materials are used as thermal barrier coatings (TBC's), as well as for wear and corrosion resistant coatings. Preferred, are particles containing aluminum oxide (Al₂O₃), aluminum oxide plus titanium oxide (Al₂O₃xTiO₂), stabilized and partially stabilized zirconium oxide (ZrO₂), and chromium oxide (Cr₂O₃), due to their properties, i.e., hardness, dielectrics, and resistance against chemical attacks etc.

Ceramic coatings have generally a high degree of porosity, which may be improved by the alloying/mixing of various oxides. In order to obtain a good bond, the substrates are roughened and coated with a bond coat, which is usually NiCr, however in the case of ZrO₂ the bond coat is a type of MCrAIY.

In preferred embodiments of the present invention there are used materials that are formed by a combination between a metallic hard phase and a metallic binder which is a hard metal. Preferably, in the present invention these materials are selected from the group consisting of tungsten carbide (WC, W₂C), and chromium carbide (Cr₃C₂) as hard phases, and cobalt and/or nickel as a ductile binder phase metal, embedding the hard phases. These materials are typically produced through powder metallurgy only, since the carbides would decompose or dissolve when smelted/fused/ liquified.

Preferably the above materials are used in the following three basic compositions:
Single-phase materials, such as metals, alloys, intermetallics, ceramics, and polymers,
Composite materials, such as cermets (WC/Co, Cr₃C₂/NiCr, NiCrAIY/Al₂O₃, etc.), reinforced metals, and reinforced polymers,
Layered or graded materials, referred to as functionally gradient materials (FGMs)

The term nano-scale particles in the present specification refers to particles in the size range of about 1 to 200 nanometer, whereas the term micron-scale particles refers to particles in the range of about 0.1 to 100 micrometer, more preferably of about 0.1 to 50 micrometer (1 nm=10⁻⁹ meter, 1 μm=10⁻⁶ meter).

Agglomerated particles differ from aggregated ones in that they are capable of being mechanically separated from one another. This is a required property in thermal sprayed processes.

In preferred embodiments the majority of said agglomerates of nano-scale particles are of a spherical shape.

Preferably, the term agglomerates of nano-scale particles as used herein refers to nano-scale particles that bond together with or without a binder having a maximum diameter of about 0.1 to 100 microns, preferably about 0.1 to 30 micron.

Companies that can supply nano-scale material in agglomerates of micro-scale include:
1. Altair Nanotechnologies; Inc. (204 Edison Way, Reno, Nev. 89502, USA);
2. Nanostructured & Amorphous Materials, Inc. (820 Krisit Lane, Los Alamos, N. Mex. 87544, USA);
3. Inframat Corporation. (74 Batterson park Rd., Farmington DT 06032, USA);
4. Nanophase Technologies, Inc. (1319 Marquette Drive, Romeoville, Ill. 60446, USA).

In a preferred embodiment of the present invention the nano-scale particles are processed into solid agglomerates. In some cases the agglomeration occurs spontaneously (e.g. titanium oxide agglomeration) while in others there is a need for binder addition, by using conventional binders as resins or paraffin and organic solvents or other conventional ones as taught in U.S. Pat. No. 6,025,034.

The feed-mixture comprising said micron-scale particles and agglomerates of nano-scale particles is heated in a gaseous medium and projected at high velocity as softened or partially molten droplets onto a substrate surface. Upon impact, the droplets typically flatten, transfer the heat to the cold substrate and solidify rapidly to form ‘splats’.

Especially preferred is a coating wherein the majority of said nano-scale particles and of said micron-scale particles is in an at least paritally molten state during the thermal spraying.

All known thermal spraying methods can be employed for the formation of the coating proposed in the present specification including plasma spraying process, for example atmospheric plasma spraying (APS) or vacuum plasma spraying (VPS) processes, flame or combustion spraying process including high velocity oxyfuel (HVOF) spraying, detonation flame spraying, flame spraying, and electric wire-arc spraying process.

While the particles are accelerated in a gas jet (flame, plasma), they are heated up and softened, and/or partially or totally melted, depending, inter alia on their residence time in the gas jet, which is a function of the average particle size distribution, and temperature distribution within the jet as well. During the flight the particles may interact with the surrounding medium, e.g., oxidation may occur due to their high temperature on their active surface when sprayed in air. In the electric wire-arc spray process, however, the sprayed materials are wires, which are melted by an electric arc. Therefore, the accelerated droplets are typically in a molten state, but their temperature starts to decrease immediately after they are formed from the wire tips.

All the conventional spraying guns can be employed for the formation of said coating proposed in the present specification, including but not limited to: F4VB® (Plasma-Technik AG, Swiss), F9-MB® (Sulzer-Metco, USA), F4-MB® (Sulzer-Metco, USA), PyroGenesis® 40 kW (PyroGensis, Canada), A-2000® (Sulzer-Metco, Swiss), SG-100® (Praxair, USA), DiamondJet2700-Hybrid® (Sulzer-Metco, USA), HV-2000® (Praxair, USA), JP-5000® (TAPA, USA).

As mentioned above the coating proposed in the present specification has improved properties compared with the conventional micron-scale coating and unexpectedly improved properties compared with coatings composed of only nano-scale particles. In particular, the addition of micron-scale particles to the nano-scale ones, formed a coating that was characterized by high resistance to cracking progression. As a result the preferred applications for the proposed coating are those for which high resistance to cracking-progression is particularly important.

Preferably, the coating presented in the present invention is used in applications in which the coated material is extremely exposed to motions like shaking, strong impact and massive movements. Therefore, high resistance to cracking-progression holds an important advantage.

In preferred embodiments said coating is used in an application selected from the group consisting of the automobile-industry, the aircraft-industry, the shipping-industry, engines, turbines, prosthetics or other applications wherein resistance to crack-progression is important.

Only U.S. Pat. No. 6,723,387 was found to describe a thermal spraying method that uses the blending of micron-scale particles with nano-scale particles, comprising the steps of: (a) blending micron-scale particles of a hard phase material arranged in particle aggregates with nano-scale particles of a binder phase material to form a uniform powder mixture; (b) aggregating the powder mixture to bond the nano-scale particles to the micron-scale thereby forming a feed stock powder comprised of aggregated particles, and (c) thermal spraying the feed stock powder of particle aggregates onto a substrate thereby forming the abrasion resistant coating thereon, the coating composed of the micron-scale particles of the hard phase material fused together with the binder phase material, which was the nano-scale particles. Thus, during thermal spraying, the nanostructured material undergoes rapid melting while the micron-scale particles are heated but not necessarily melted.

U.S. Pat. No. 6,723,387 differs from the present invention by at least two basic aspects: (1) U.S. Pat. No. 6,723,387 describes aggregates composed of nano-scale particles with micron-scale particles, whereas in the present invention the agglomerates are comprised only of nano-scale particles; (2) U.S. Pat. No. 6,723,387 teaches aggregation before spraying of aggregates formed from both the nano-scale particles with the micron-scale particles, whereas in the present invention agglomeration is only of the nano-scale particles which agglomerates preferably have the same size as the separate micro particles so that both can be sprayed using the same equipment.

It will be evident to those skilled in the art that the invention is not limited to the details of the foregoing description and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

What is claimed is:

1. A coating formed by thermal spraying of a feed-composition, said feed-composition comprising:
a) discreet micron-scale particles; and
b) discreet agglomerates of nano-scale particles.

2. A coating according to claim 1 wherein the weight ratio between said micron-scale and nano-scale particles is between about 10:90 and about 90:10.

3. A coating according to claim 1 wherein the weight ratio between said micron-scale and nano-scale particles is between about 10:90 and about 45:55.

4. A coating according to claim 1 wherein the weight ratio between said micron-scale and nano-scale particles is approximately constant.

5. A coating according to claim 1 comprising at least two layers which having different ratios between said micron-scale and nano-scale particles.

6. A coating according to claim 1 wherein the weight ratio between said micron-scale and nano-scale particles varies along the coating.

7. A coating according to claim 1 wherein the majority of said agglomerates is in a spherical shape.

8. A coating according to claim 1 wherein the majority of said nano-scale particles and of said micron-scale particles are at least softened during the thermal spraying.

9. A coating according to claim 1 wherein the size ratio between said discreet micron-scale particles and said discreet agglomerates of nano-scale particles is between 1:3 and 3:1.

10. A coating according to claim 1 wherein said feed composition is in a form selected from the group consisting of powders, wires and. solutions.

11. A coating according to claim 1 wherein said feed composition is in powder form.

12. A coating according to claim 1 wherein said coating is used in an application selected from the group consisting of the automobile-industry, the aircraft-industry, the shipping-industry, engines, turbines, prosthetics or other applications wherein resistance to crack-progression is important.

13. An article of manufacture whenever provided with a coating composition according to claim 1.

14. A method for the formation of a coating comprising the steps of:
a) preparing a feed-composition comprising discreet micron-scale particles and discreet agglomerates of nano-scale particles; and
b) thermal spraying said feed-composition onto a surface.

15. A method according to claim 14 wherein the weight ratio between said micron-scale and nano-scale particles is between about 10:90 and about 90:10.

16. A method according to claim 14 wherein the weight ratio between said micron-scale and nano-scale particles is approximately constant.

17. A method according to claim 14 wherein said thermal spraying includes at least two layers, said layers having different ratios between said micron-scale and nano-scale particles.

18. A method according to claim 14 wherein the weight ratio between said micron-scale and nano-scale particles varies along the coating.

19. A method according to claim 14 wherein the majority of said agglomerates is in a spherical shape.

20. A method according to claim 14 wherein the majority of said nano-scale particles and of said micron-scale particles are at least softened during said thermal spraying.

21. A method according to claim 14 wherein said feed composition is in a form selected from the group consisting of powders, wires and solutions.

22. A method according to claim 14 wherein said feed composition is in powder form.

23. A method according to claim 14 used in an application selected from the group consisting of the automobile-industry, the aircraft-industry, the shipping-industry, engine coatings, turbine coatings, coatings for prosthetics or other applications wherein resistance to crack-progression is important.

24. A method according to claim 14 wherein the discreet agglomerates of nano-scale particles are formed to be substantially of the same size as the discreet micron-scale particles.
